(19) United States
(12) Patent Application Publication
(10) Pub. No.: US 2025/0217999 A1
(43) Pub. Date: Jul. 3, 2025

(54) SYSTEM, METHOD, AND DEVICE FOR CAPTURING HIGH RESOLUTION IMAGES OVER A PANORAMIC SCENE IN NEAR AND FAR FIELDS FOR IMAGING OF PERSONS

(71) Applicants: James Elder, Toronto (CA); Helio Perroni Filho, Toronto (CA); Aleksander Trajcevski, Scarborough (CA); Kartikeya Bhargava, Toronto (CA); Nizwa Javed, Ajax (CA); Mohammad Akhavan, Toronto (CA)

(72) Inventors: James Elder, Toronto (CA); Helio Perroni Filho, Toronto (CA); Aleksander Trajcevski, Scarborough (CA); Kartikeya Bhargava, Toronto (CA); Nizwa Javed, Ajax (CA); Mohammad Akhavan, Toronto (CA)

(21) Appl. No.: 18/403,306

(22) Filed: Jan. 3, 2024

(51) Int. Cl. G06T 7/20; G06T 7/50; G06V 10/25; G06V 10/44; G06V 10/74; G06V 40/16

(52) U.S. Cl. CPC G06T 7/20; G06T 7/50; G06V 10/25; G06V 10/44; G06V 10/761; G06V 40/172; G06V 2201/07

(57) ABSTRACT

There is provided a method, system, and device for capturing high resolution images of a scene for analysis of one or more persons. The method includes: receiving one or more pre-attentive images, the one or more pre-attentive images capturing the scene; detecting one or more persons in the one or more pre-attentive images; determining a feature vector and a geo-location for at least one of the detected persons in the pre-attentive image; matching the feature vector and geo-location to a previously detected person for tracking of such detected person, and where there is no match, initializing a tracking of a new person; receiving an attentive image that captures the detected person by directing gaze at a specified azimuthal location, the attentive image comprising a smaller field-of-view (FoV) than the one or more pre-attentive images; and outputting the attentive image.

### TECHNICAL FIELD

The following relates generally to video processing for robotics; and more particularly, to a system, method, and device for capturing high resolution images over a panoramic scene in near and far fields for imaging of persons.

### BACKGROUND

Robots that interact with humans, broadly referred to as ‘social robots’, represent an area of technology that strives to create machines capable of perceiving and responding to human interactions, such as emotions, gestures, and verbal cues. In general, social robots strive to engage with humans in a manner that simulates human-like interaction. Social robots can have applications in many various fields; for example, healthcare, customer service, education, and entertainment. However, significant challenges persist in creating social robots that seamlessly interact with humans.

### SUMMARY

In an aspect, there is provided a computer-implemented method for capturing high resolution images of a scene for analysis of one or more persons, the scene comprising the one or more persons to be analyzed, the method comprising: receiving one or more pre-attentive images, the one or more pre-attentive images capturing the scene; detecting one or more persons in the one or more pre-attentive images; determining a feature vector and a geo-location for at least one of the detected persons in the pre-attentive image, the geo-location comprising an azimuthal location; matching the feature vector and geo-location to a previously detected person for tracking of such detected person, and where there is no match, initializing a tracking of a new person; receiving an attentive image that captures the detected person by directing gaze at the azimuthal location, the attentive image comprising a smaller field-of-view (FoV) than the one or more pre-attentive images; and outputting the attentive image.

In a particular case of the method, identifying the detected person comprises performing facial analysis and wherein receiving the attentive image that captures the detected person by directing gaze at the azimuthal location is performed when a face of the detected person is capturable within the field of view of the attentive image.

In another case of the method, when the face of the detected person is not capturable within the field of view of the attentive image, the method further comprising extracting a cropped portion of the pre-attentive image associated with a facial region of the detected person.

In yet another case of the method, the one or more pre-attentive images comprise a panoramic view of the scene.

In yet another case of the method, the method further comprising recognizing the detected person by matching a vector associated with the detected person to vectors in a data store, and outputting a positive recognition where the vector is matched to the data store, and outputting a negative recognition otherwise.

In yet another case of the method, the one or more pre-attentive images comprises depth information, and wherein receiving the attentive image further comprises pre-focusing using a focus determined from the depth information.

In yet another case of the method, the tracking uses ground-plane coordinates.

In yet another case of the method, detection of the one or more persons comprises a bounding box around the detected person, wherein where depth information is available within the bounding box and a central tendency of the depth information is less than a predetermined distance, geo-location of the detected person comprises an azimuth of a spatial parameter of the bounding box at a distance determined by a central tendency of the depth information within the bounding box, and wherein where depth information is not available within the bounding box or the central tendency of the depth information exceeds the predetermined distance, geo-location of the detected person comprises back-projecting a center of the bottom of the bounding box to a ground plane.

In yet another case of the method, matching the feature vector and the geo-location to the previously detected person comprises using a metric that combines a distance measure between feature vectors and Euclidean distance in ground plane coordinates.

In another aspect, there is provided a system for capturing high resolution images of a scene for analysis of one or more persons, the scene comprising the one or more persons to be analyzed, the system comprising one or more processors in communication with a data storage, the system in communication with one or more pre-attentive cameras and an attentive camera, the one or more processors, using instructions stored on the data storage, are configured to execute: a pre-attentive module to receive one or more pre-attentive images from the one or more pre-attentive cameras, the one or more pre-attentive images capturing the scene, to detect one or more persons in the one or more pre-attentive images, to determine a feature vector and a geo-location for at least one of the detected persons in the one or more pre-attentive images, the geo-location comprising an azimuthal location, and to match the feature vector and geo-location to a previously detected person for tracking of such detected person, and where there is no match, initializing a tracking of a new person; an attentive module to receive an attentive image that captures the detected person by directing a gaze of the attentive camera at the azimuthal location, the attentive image comprising a smaller field-of-view (FoV) than the one or more pre-attentive images; and an output module to output the attentive image.

In a particular case of the system, identifying the detected person comprises performing facial analysis, and wherein receiving the attentive image that captures the detected person by directing gaze at the azimuthal location is performed when a face of the detected person is capturable within the field of view of the attentive image.

In another case of the system, when the face of the detected person is not capturable within the field of view of the attentive image, the attentive module extracts a cropped portion of the pre-attentive image associated with a facial region of the detected person.

In yet another case of the system, focusing is performed approximately in parallel with directing the gaze of the attentive camera at the azimuthal location.

In yet another case of the system, the tracking uses ground-plane coordinates, and wherein detection of the one or more persons comprises a bounding box around the detected person, wherein where depth information is available within the bounding box and a central tendency of the depth information is less than a predetermined distance, geo-location of the detected person comprises an azimuth of a spatial parameter of the bounding box at a distance determined by a central tendency of the depth information within the bounding box, and wherein where depth information is not available within the bounding box or the central tendency of the depth information exceeds the predetermined distance, geo-location of the detected person comprises back-projecting a center of the bottom of the bounding box to a ground plane.

In yet another case of the system, matching the feature vector and the geo-location to the previously detected person comprises using a metric that combines a distance measure between feature vectors and Euclidean distance in ground plane coordinates.

In another aspect, there is provided a device for capturing high resolution images of a scene for analysis of one or more persons, the scene comprising the one or more persons to be analyzed, the device comprising: one or more pre-attentive cameras positioned to capture one or more pre-attentive images that combined provide a panoramic view of the scene; a mirror mounted on a controllable structure to direct a gaze of the mirror to a specified area of the panoramic view, the specified area comprising the person to be analyzed; an attentive camera directed towards the mirror to capture an attentive image comprising the directed gaze of the mirror of the scene, the attentive image comprising a smaller field-of-view (FoV) than the combination of the one or more pre-attentive images.

In a particular case of the device, the mirror is positioned at an oblique angle relative to horizontal, and wherein the attentive camera is directed towards the mirror and positioned above or below the mirror.

In another case of the device, the panoramic view comprises a 360-degree panoramic view and wherein the controllable structure comprises a motor that provides 360-degree rotation of the mirror to permit 360-degree azimuthal fixations over the panoramic view.

In yet another case of the device, the controllable structure further comprises a second motor to control an elevation of the gaze of the mirror.

In yet another case of the device, the one or more pre-attentive images are used to detect one or more persons in the one or more pre-attentive images and used to determine a feature vector and a geo-location for at least one of the detected persons in the pre-attentive image, the geo-location comprising an azimuthal location, wherein the motor directs the gaze of the mirror to the azimuthal location, and wherein the attentive image captured by the attentive camera comprises an image of the azimuthal location.

These and other aspects are contemplated and described herein. It will be appreciated that the foregoing summary sets out representative aspects of the system, device, and method to assist skilled readers in understanding the following detailed description.

### BRIEF DESCRIPTION OF THE DRAWINGS

A greater understanding of the embodiments will be had with reference to the figures, in which:

FIG. 1 illustrates a block diagram of a system for capturing high resolution images over a panoramic scene in near and far fields for facial imaging, according to an embodiment;

FIG. 2 illustrates a flow diagram of a method for capturing high resolution images over a panoramic scene in near and far fields for facial imaging, according to an embodiment;

FIG. 3A illustrates a perspective rendering of a device for capturing high resolution images over a panoramic scene in near and far fields for facial imaging, showing a camera and mirror geometry that can be used for holonomic robotics applications;

FIG. 3B illustrates a perspective photograph of a prototype of the device of FIG. 3B;

FIG. 4 illustrates an example functional pipeline for implementation of the system of FIG. 1;

FIG. 5 illustrates a conceptual flow diagram for an implementation of the system of FIG. 1 for person detection and tracking in three-dimensional (3D) space using an array of red-green-blue-depth (RGBD) cameras;

FIG. 6 illustrates an example of a pre-attentive image captured by a pre-attentive camera;

FIG. 7 illustrates an example of an attentive image captured by an attentive camera from the example of FIG. 6;

FIG. 8 illustrates an example set of reference images for face recognition using the system of FIG. 1;

FIG. 9 illustrates a first environment where the system of FIG. 1 was tested in accordance with example experiments;

FIG. 10 illustrates a second environment where the system of FIG. 1 was tested in accordance with the example experiments;

FIG. 11 is a chart illustrating attentive face detection performance in the example experiments;

FIG. 12 is a chart illustrating performance of face recognition model on pre-attentive images in the example experiments;

FIG. 13 is a chart illustrating performance of face recognition model on attentive images in the example experiments;

FIG. 14 is a chart illustrating performance differences between attentive and pre-attentive receiver operating characteristic (ROC) curves to show improvement in face recognition performance due to attentive sensing in the example experiments;

FIG. 15 is a chart illustrating attentive boost in face recognition performance in the example experiments;

FIG. 16 is a diagram illustrating an example of attentive and pre-attentive imaging fields in accordance with the system of FIG. 1;

FIG. 17 is a diagram illustrating how distance to a person is calculated based upon the detection bounding box, where distance is used to establish a geolocation of the person and to pre-focus an attentive camera to avoid delay once the attentive gaze has been deflected to fixate on the selected person; and

FIG. 18 illustrates an example of pre-attentive and attentive sensing in a near field and far field, in accordance with the system of FIG. 1.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, or device exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer-readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application, or module herein described may be implemented using computer readable/executable instructions that may be stored or otherwise held by such computer-readable media and executed by the one or more processors.

The following relates generally to video processing; and more particularly, to a system, method, and device for capturing high resolution images over a panoramic scene in near and far fields for facial imaging for facial imaging.

Generally, a social robot, i.e., a robot that interacts with humans, should reliably detect, recognize and judge social characteristics of people in all visual directions and in both near and far fields. To work well with human populations, the robot should be broadly socially aware, able to detect and recognize the people around it in the environment, identify human attributes (e.g., age, gender, facial expression), and estimate emotional states and intentions. This requires visual sensing with a very wide (ideally panoramic) sensory Field-of-View (FoV); for example, to avoid blind spots, i.e., directions in which the robot is unaware of human occupancy or activity. At the same time, identifying individuals, estimating traits and understanding intent in the far field generally requires high spatial acuity; for example, to support face or expression recognition or estimation of gaze direction. For a fixed sensor pixel resolution, this results in a resolution and FoV trade-off; where expansion of the FoV to support wide-field awareness leads to a reduction in acuity needed for interpretation, especially in the far field.

The human visual system addresses this trade-off by having a wide-field binocular visual system, a fast and accurate oculomotor plant, spatial remapping and short-term memory systems that integrate over time. Foveation of the retina allows for instantaneous processing of fine spatial detail at selected gaze points in the scene, typically sampled at a rate of 2-3 fixations per second. Due to the exponential falloff in acuity with eccentricity, human visual performance depends profoundly on judicious selection of gaze points and accurate interception of gaze targets. For robots to operate successfully in social environments they must solve many of the same problems as humans, and in particular, balance the trade-off between whole-field 3D spatial awareness and the ability to process finer detail in the parts of the scene relevant to the task at hand.

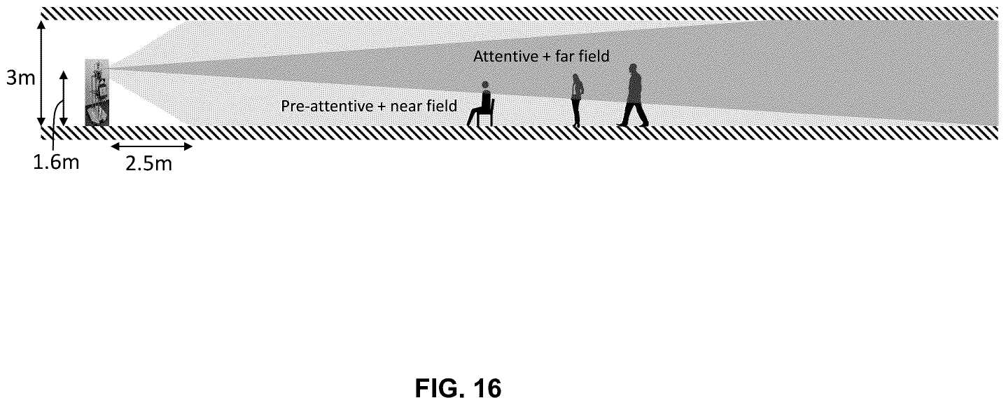

To address these major challenges, the present embodiments provide an attentive sensing approach. Panoramic low-resolution pre-attentive sensing can be provided by an array of wide-angle cameras, while attentive sensing can be achieved with a high-resolution, narrow field-of-view camera and a mirror-based gaze deflection system. In example experiments conducted by the present inventors, quantitative evaluation on a novel dataset showed that this attentive sensing approach yielded effective panoramic face recognition performance out to distances of approximately 35 metres. As described herein, and as illustrated in the diagram of FIG. 16, the present embodiments provide an approach for achieving high-resolution panoramic images in both lower and upper fields, and both near and far fields. FIG. 16 illustrates how complications of having second motor to adjust the elevation of the attentive gaze can be avoided by employing the pre-attentive sensors for facial analysis when the selected person's face is predicted to be outside the attentive FOV, and therefore in the near field; and therefore, close enough for pre-attentive resolution to be sufficient.

Some approaches for attentive machine vision employ two cameras, a wide-field (e.g., 130-degree FoV) pre-attentive camera 194 mounted in close proximity to a second narrow-field (e.g., 13-degree FoV) camera on a pan-tilt unit. In such approaches, people are detected in the pre-attentive video stream and pan/tilt control is used to direct the attentive sensor to these saccadic targets, allowing high-resolution capture. In practice, such approaches were not able to support biometrics, including face recognition in the far field, because face recognition only performed well under close-range, controlled conditions. In some approaches, active near-IR illumination and sensing can be used to allow low-light operation, with an attentive system consisting of a single wide-angle pre-attentive camera 194 and two narrow-FoV attentive cameras 190 on pan-tilt units. Such approaches generally provide some improvement in face recognition performance for attentive over pre-attentive sensing, but only for a single image containing no more than three people.

Generally, approaches for attentive machine vision can be used in fixed installations of cameras, such as for surveillance applications. However, the maturation of mobile robot technologies raises the possibility of incorporating attentive sensing into robot architectures to improve social awareness in the far field. Embodiments of the present disclosure resolution are advantageously applicable to use in such mobile robot technologies. Thus, unlike other approaches, the present embodiments can advantageously be used for attentive face recognition accuracy in the far field, such as those suitable for social robot applications.

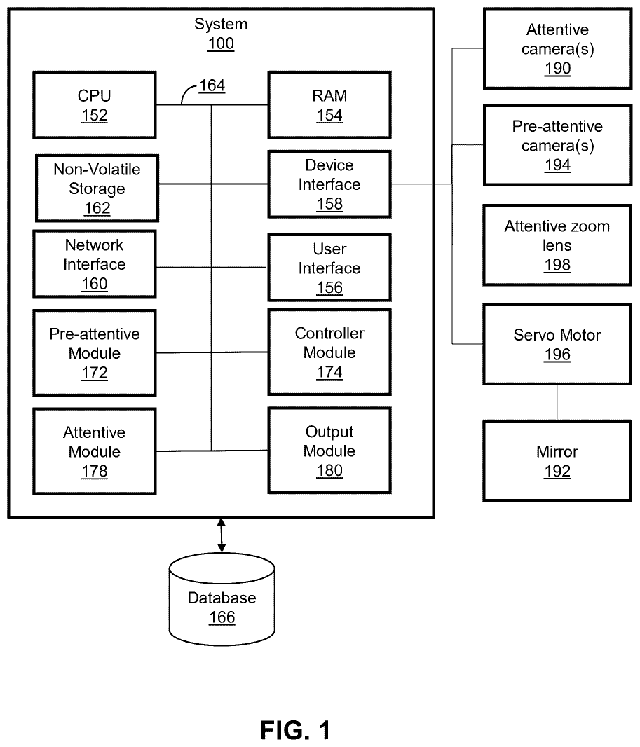

Turning to FIG. 1, a system 100 for capturing high resolution images of a scene for analysis of one or more persons is shown, according to an embodiment. In this embodiment, the system 100 is run on a local computing device (for example, a computer located on a mobile robot). In further embodiments, the system 100 can be run on any other computing device; for example, a server, a dedicated piece of hardware, a laptop computer, or the like. In some embodiments, the components of the system 100 are stored by and executed on a single computing device. In other embodiments, the components of the system 100 are distributed among two or more computer systems that may be locally or remotely distributed; for example, using networked connections or cloud-computing resources.

FIG. 1 shows various physical and logical components of an embodiment of the system 100. As shown, the system 100 has a number of physical and logical components, including a central processing unit (“CPU”) 152 (comprising one or more processors), random access memory (“RAM”) 154, a user interface 156, a device interface 158, a network interface 160, non-volatile storage 162, and a local bus 164 enabling CPU 152 to communicate with the other components. CPU 152 executes the various conceptual modules, as described below in greater detail, which may be within the context of an operating system. RAM 154 provides relatively responsive volatile storage to CPU 152. The user interface 156 enables an administrator or user to provide input via an input device, for example a mouse or a touchscreen. The user interface 156 can also output information to output devices, such as a display or speakers. In some cases, the user interface 156 can have the input device and the output device be the same device (for example, via a touchscreen). The device interface 158 communicates with devices used by the system 100, such as, one or more attentive cameras 190, one or more pre-attentive cameras 194, a servo motor 196, and an attentive zoom lens 198. In further embodiments, the system 100 can retrieve images already recorded by the one or more attentive cameras 190 and/or the one or more pre-attentive cameras 194 from the local database 166 or from a remote database via the network interface 160.

The network interface 160 permits communication with other systems, such as other computing devices and servers remotely located from the system 100, such as for a typical cloud-computing model. Non-volatile storage 162 stores the operating system and programs, including computer-executable instructions for implementing the operating system and modules, as well as any data used by these services. Additional stored data can be stored in a database 166. During operation of the system 100, the operating system, the modules, and the related data may be retrieved from the non-volatile storage 162 and placed in RAM 154 to facilitate execution.

In an embodiment, the system 100 further includes a number of modules to be executed on the one or more processors 152, including a pre-attentive module 172, a controller module 174, an attentive module 178, and an output module 180.

Generally, in the present embodiments, the pre-attentive camera(s) 190 (such as a fixed wide-field pre-attentive camera array of multiple cameras) are used for pre-attentive object detection and tracking as well as near-field facial analysis. Additionally, the attentive camera(s) 190 are used for attentive sensing in the far field.

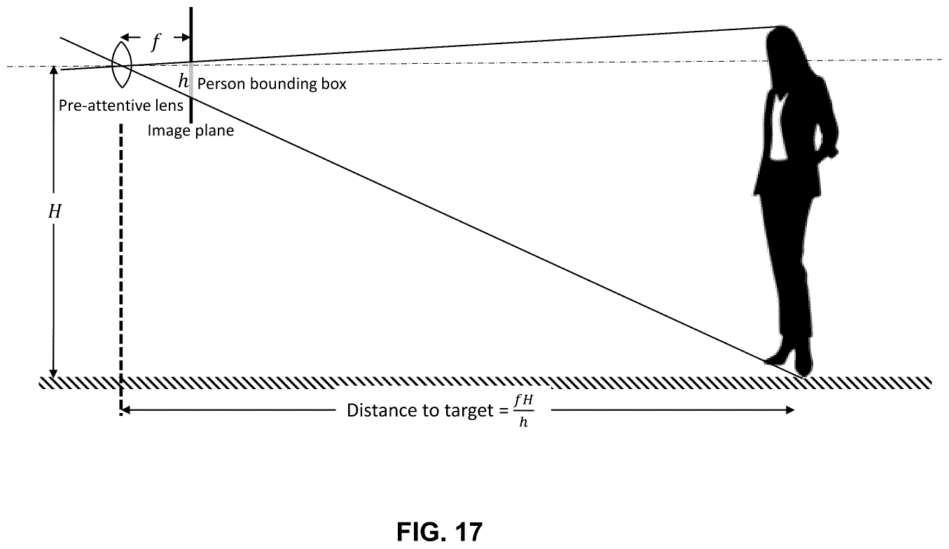

Generally, to provide high resolution in the far field, the lens of the attentive camera 190 has a long focal length. Since depth of field is inversely proportional to the square of the focal length, the attentive depth of field is typically quite small. In practical situations, people may be at widely varying distances from the sensors; and thus, the lens should be accurately refocused between fixations. However, waiting for fixation to be complete before focusing introduces substantial delays and a reduction in fixation rate. In the present embodiments, refocusing can advantageously commence as soon as the target person is detected in the pre-attentive stream; where refocusing can be completed in parallel, or approximately at the same time, to refixation, accomplished through mirror rotation. This pre-emptive refocusing generally necessitates an estimate of the distance of the person selected for attentive fixation. This distance estimate can be obtained through two mechanisms. For near-field targets (within roughly 6 meters of the sensor), the pre-attentive cameras 190 with depth sensing, such as RGBD cameras, provide a reliable determined distance to the person via the depth sensing and can be used to set the focus when a target person has been pre-attentively detected. For targets at greater distances, for example greater than 6 meters, a distance to the captured person can be determined using the bottom of a bounding box capturing the person, which can be back-projected to the ground plane to determine the focus distance (i.e., the depth information); which is illustrated in the diagram of FIG. 17.

FIG. 17 depicts an example scenario that is typical for an indoor environment with a 3-meter ceiling height. The system 100 can be mounted at eye height (e.g., 1.5 meters). The wide pre-attentive FOV allows people to be reliably detected regardless of their height, whether they are sitting or standing, in both near and far fields. The faces of all adults in the far field, whether they are an adult or a child, and whether they are standing or sitting, will fall within the attentive camera's FOV. However, the faces of adults standing in the near field or sitting in the mid-field, and of small children in either near or mid-fields, will generally not fall within the attentive FOV and therefore must be analyzed in the pre-attentive sensor stream. Fortunately, since these individuals will generally be close to the robot, pre-attentive resolution may be sufficient.

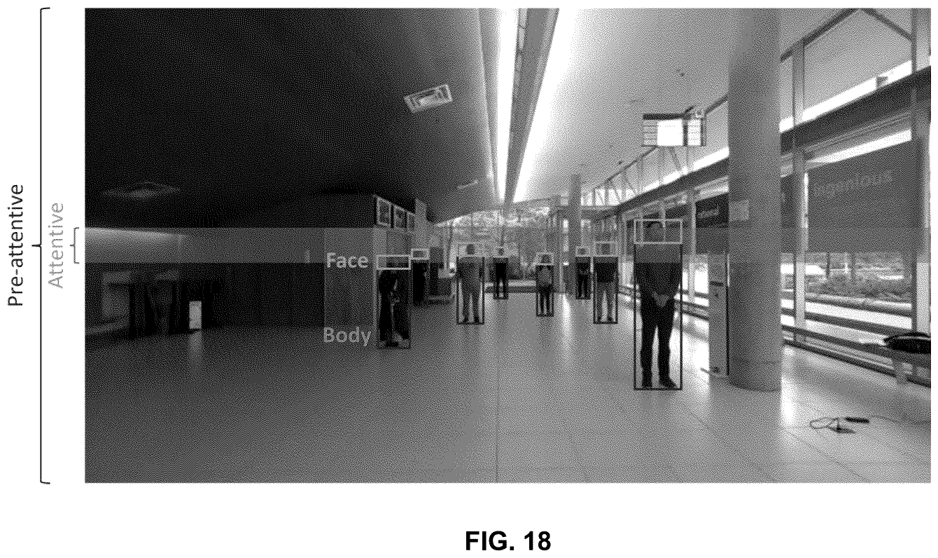

Whether a face should be processed attentively can be determined through an analysis of the detected body bounding box (as illustrated in FIG. 18) to predict whether such person's face can be captured by the attentive camera 190. The human head is generally less than 25.5 centimeters in height. Given the estimated distance of the target (as described herein), projective geometry can be used to determine the upper region of the body bounding box that a head of this maximal size would occupy (h=25.5 f/D, where f is the focal length of the pre-attentive camera in pixels, D is the estimated distance to the target in centimeters and h is the estimated maximal height of the face in the image, in pixels). If this region lies entirely within the attentive FOV, the head can be fixated for attentive analysis. Otherwise, the head can be processed pre-attentively.

In an example, and without loss of generality, the system 100 can be conceptualized into various components:
Pre-attentive camera(s) (for example, multi-camera RGBD (red-green-blue (RGB) and depth (D))) for tracking by the pre-attentive module 172 in order to provide pre-attentive panoramic human tracking using ground-plane coordinates;
A motor 196 (e.g., servo) instructed by the controller module 174 that rotates a mirror 192 to deflect attentive gaze to a person of interest;
A bridge node (such as in a robot operating system (ROS)) for capturing attentive images from attentive camera(s) that can then be used by the pre-attentive module 172 or the attentive module 178;
Attentive face analysis to precisely localize the face and extract useful information (e.g., identity, age, gender, expression, etc.); and
An attentive module 178 that associates this information with a tracked individual.

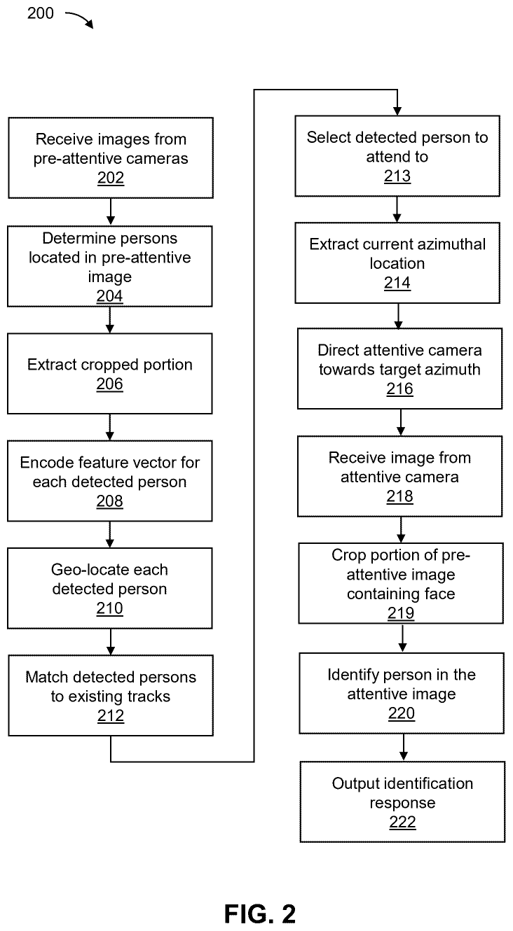

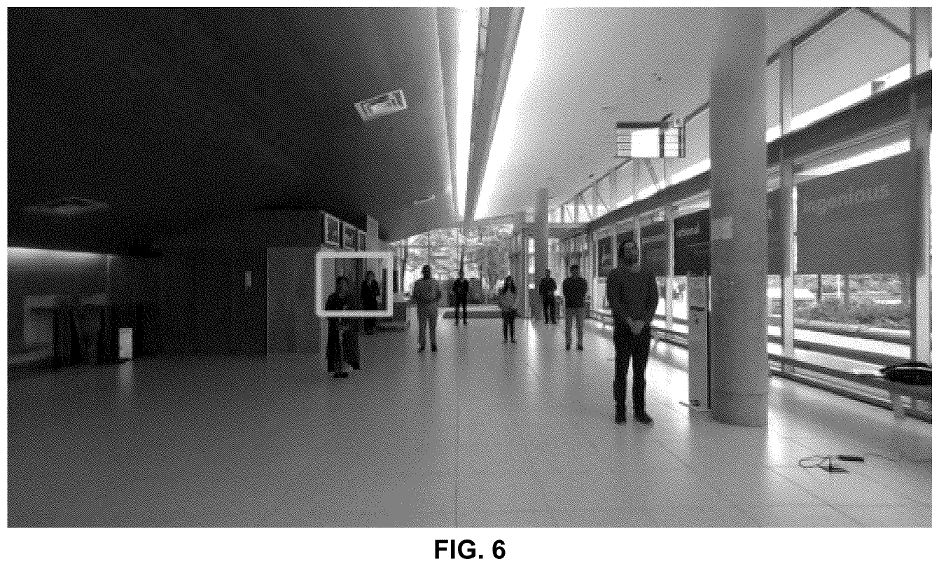

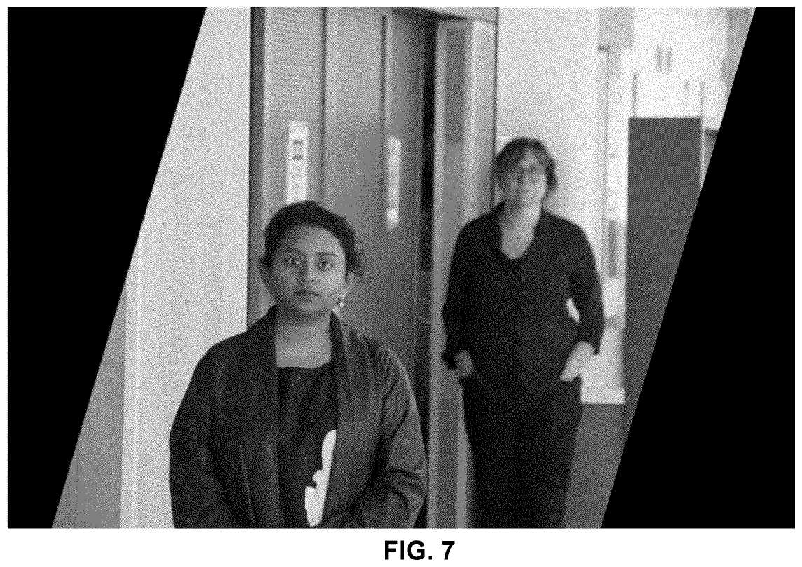

FIG. 2 illustrates a method 200 for capturing high resolution images of a scene for analysis of one or more persons, in accordance with an embodiment. At block 202, the pre-attentive module 172 receives timestamped images from one or more pre-attentive cameras 194; for example, images from four RGBD cameras. Where there is more than one pre-attentive camera 194, the images from the multiple cameras can be synchronized in time. The one or more pre-attentive cameras 194 capturing a wide FoV of a scene in which a person is present; in most cases, a panoramic FoV of greater than 180-degrees. FIG. 6 illustrates an example of a pre-attentive image captured by a pre-attentive camera 194; where the inset bounding box indicates a gaze direction for the example attentive image illustrated in FIG. 7.

In some cases, the photographic image (e.g., RGB image) and depth image can be captured separately by the same sensor or by different sensors. In an example, such images can be captured by a set of bridge nodes running on onboard hardware of a robot and then transmitted to an external server for processing.

At block 204, the pre-attentive module 172 detects whether one or more persons are located in the pre-attentive image using a suitable object detector; for example, using a YOLOv4object detector, Cascade RCNN, CenterNet, InternImage, or the like. Such object detectors are generally convolutional or transformer deep neural networks that are trained on large datasets, such as MS COCO, to detect, localize, and classify various types of objects; although other suitable forms of object detectors can be used. While the present embodiments generally describe detection of persons/humans, it is understood that system 100 could likewise be used for fine-grained analysis of other types of objects in the far field.

In some cases, at block 206, for each detected person in the pre-attentive image, the pre-attentive module 172 extracts a cropped portion of the image where the person was detected. At block 208, the pre-attentive module 172 extracts a feature vector that represents the appearance of the detected person, in some cases, using the cropped image to generate the vector. This feature vector is subsequently used to track individuals over time, which is described with respect to block 212 herein. The feature vector can be determined using any suitable approach, for example, using a wide residual network or any other form of network trained to form an embedding that is useful for re-identification.

At block 210, in some cases, the pre-attentive module 172 geolocates each person detected in the image. If the pre-attentive camera 194 provides depth data within the bounding box, and a central tendency (such as a mean) of this depth data is less than a predetermined distance (e.g., 6 metres), the person can be geolocated at the azimuth of the bounding box centroid at a distance determined by the central tendency of the depth distances within the bounding box. If the bounding box contains no depth information, or the average exceeds the predetermined distance (i.e., beyond a reliable range), the pre-attentive module 172 can back-project the center of the bottom of the bounding box that was determined by the object detector to the ground plane, using a pre-determined projection matrix for the pre-attentive camera 194.

The geo-located detections, which include the feature vector of the detected person and their associated ground plane coordinates, are used for tracking. At block 212, the pre-attentive module 172 can match the detections of persons in the pre-attentive image to existing tracks, if there are stored existing tracks; for example, through use of the Hungarian algorithm, a greedy algorithm, or any other suitable approach to the bipartite matching problem. The matching can be based on any metric that combines appearance similarity (defined as the cosine distance or other distance measure between feature vectors) and Euclidean distance in ground plane coordinates, for example, using a weighted sum. Any detection not matched to an existing track can be used by the pre-attentive module 172 to initialize a new track. In some cases, any track not matched for longer than a predetermined threshold period can be discarded by the pre-attentive module 172. In some cases, a Kalman filter can be used to predict a current position of each tracked person before tracks are matched to the most recently received pre-attentive image.

Advantageously, due to the fact that tracks are located in a ground-plane space, and not image coordinate space, a single track can seamlessly transition between cameras, allowing consistent person tracking across the entire panoramic pre-attentive FoV. However, in other embodiments, tracks in the image coordinate space can be used, but will generally be less advantageous.

Using the tracks of each of the persons in the pre-attentive images, the system 100 provides attentive observation to one or more of the tracked persons; for example, which can be used to perform facial recognition of the tracked person or to perform other social analysis (for example, determinations of gender, age, facial expression, gaze direction, whether the tracked person is speaking, whether the tracked person is wearing a mask, or the like).

At block 213, the pre-attentive module 172 selects a detected person in the pre-attentive image to provide attention on. This selected person could be a person that the system 100 has not yet attended to, a person that the system 100 has not attended to for a certain period of time, or a person who is associated with some other aspect (for example, the person is approaching the pre-attentive camera). Once selected, an attentive image of such detected person can be captured, as described herein.

In some cases, each tracked person in the pre-attentive panoramic view can be fixated in turn. Once a person has been attentively fixated and analyzed in a subsequent attentive image, another person that has not yet been attentively fixated can be selected for attentive processing. Once all suitable persons have been fixated, the system 100, if mounted on a mobile platform such as a holonomic robot, can be moved to another position where previously unseen people may be visible. However, it is to be understood that any other suitable selection schemes can be used; for example, through randomization.

At block 214, the attentive module 178 can select one of the tracks and extract the detected person's current azimuthal location using the geo-located information. Based upon the estimated distance and the bounding box, the attentive module 178 can determine whether the face of the detected person is expected to lie within the attentive FoV. If it is, at block 216, the controller module 174 instructs the motor 196 (e.g., servo) to direct a gaze of the attentive camera 190 towards the target azimuth. While the present disclosure generally describes use of a motor-mounted mirror 192 to direct the gaze of the attentive camera 190, it is understood that any suitable approach for directing the gaze of the attentive camera 190 can be used; including having the attentive camera 190 moveable by a motor.

At block 218, the attentive module 178 receives an image (i.e., a frame) from the attentive camera 190 focused on a detected person(s), such received image is an attentive image. FIG. 7 illustrates an example of the attentive image associated with the example pre-attentive image of FIG. 6. The trapezoidal attentive FoV arises from the oblique azimuthal orientation of the mirror 192 relative to the attentive camera 190 plane axes. This attentive image can be cropped if desired to form a more conventional rectangular or circular image.

While FIG. 7 illustrates an image captured by the attentive camera 190 using a standard RGB imaging modality, it is understood that the attentive camera 190 can use any suitable imaging modality; for example, near-infrared, thermal infrared, ultrasonic, ultraviolet or the like.

At block 219, if the face of the detected person is determined or predicted to lie outside the attentive FoV, the face does not lie in the far field, and therefore, can be analyzed using the pre-attentive camera 194. In such cases, the attentive module 178 can generate the attentive image by extracting a crop of the pre-attentive image that contains the face of the detected person (for example, consisting of the top 38% of the pre-attentive bounding box of the body) for analysis; such as for identification or other social analysis (e.g., determinations of facial expression, direction of eye gaze, gender, age, whether the person is speaking, and/or the like).

At block 220, in some cases, for each of the detected persons, the attentive module 178 uses the geo-location information and extracted feature vectors to associate the detections in the current pre-attentive imagery with the existing tracks. In the case of a detection that is not associated with any track, a new track can be created.

In some cases, the attentive module 178 can recognize the tracked person using face recognition, for example, using the deepFace Python framework. In some cases, the attentive module 178 can be initialized with a data store of reference face images each associated with a unique identifier. When initialized, the attentive module 178 loads the reference data store and builds a dictionary of face vectors indexed by identifier using the face recognition model. These face vectors can be embeddings of the information contained in images of faces, learned from large facial recognition datasets. The attentive module 178 can use any suitable face recognition approach that summarizes a facial image into a smaller vector while preserving identity information, such as using a deep convolutional model or transformer network. In an example, the attentive module 178 can identify whether an individual represented in the reference data store matches one of the tracked persons in the attentive image, by: (1) retrieving face vectors corresponding to the queried face identifier in the reference data store; (2) detecting faces in the attentive image; (3) determining the face vector for each detected face; (3) determining a cosine distance between each of the detected face vectors and the queried face identifier in the reference data store; and (5) If the minimum cosine distance is below a pre-determined threshold, return a positive identifier response, and otherwise, return a negative identifier response.

At block 222, the output module 180 outputs the attentive image to the user interface 156, the database 166, the non-volatile storage 162, and/or the network interface 160. In some cases, the output module 180 also outputs the positive identification response or negative identification response. In further cases, the output module 180 can also output the identification of the tracked person and/or the geo-location of the tracked person.

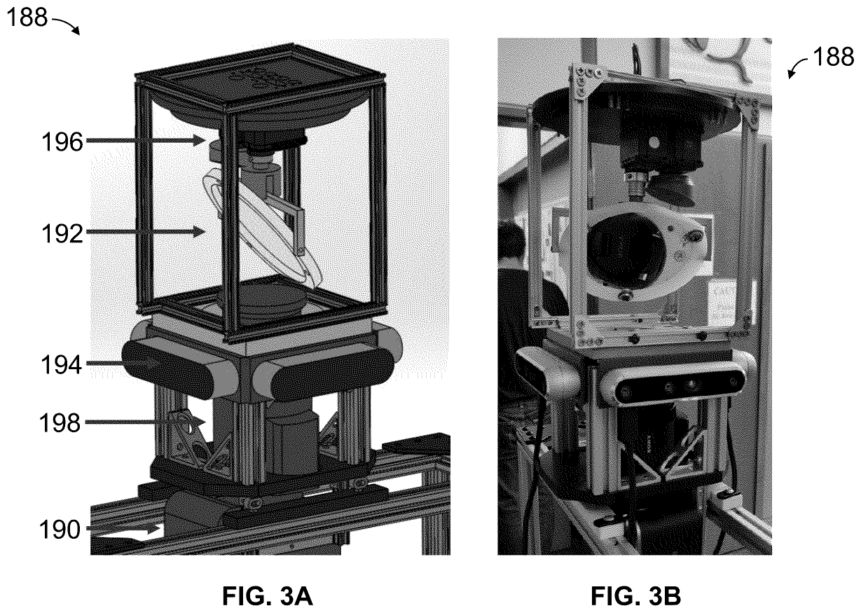

FIGS. 3A and 3B illustrate a 3D-rendering and a photograph, respectively, of an embodiment of device 188 for capturing high resolution images over a panoramic scene in near and far fields for facial imaging; which is an implementation of the system 100 that is used in the example experiments. In this case, the device 188 is mounted atop a mobile robot (for example, a holonomic base), which is atop a frame that allows the camera to be at approximately human height (1.6 metres). The device 188, in this embodiment, generally includes a pre-attentive sensing portion and an attentive sensing portion with attentive gaze control. In the pre-attentive sensing portion, there are one or more pre-attentive cameras 194 (in this example, four pre-attentive cameras) located around the structure such that when the captured images are combined, the pre-attentive cameras 194 provide a panoramic view, which can be a view between 180-degrees and 360-degrees. In further implementations, the pre-attentive sensing portion can include any suitable number of pre-attentive cameras 194 to span any suitable panoramic view. The attentive sensing portion includes an attentive camera 190 with, in this case, an attentive zoom lens 198 located on the camera 190. The attentive zoom lens 198 is directed to an oblique angled mirror 192. The mirror 192 is located above the attentive camera 190 such that the lens of the attentive camera 190 is directed upwards towards the mirror 192. The mirror 192 is positioned at an angle such that the view at the determined azimuth, as described herein, is reflected down towards the lens of the attentive camera 190. The mirror 192 is mounted on a controllable structure comprising a motor 196 that can rotate the mirror 192 (e.g., rotate 360-degrees) in order to direct the azimuth of gaze of the attentive camera 190 to any azimuth in order to fixate the gaze of the attentive camera on a detected person. In such an arrangement, the attentive camera 190 is essentially mounted vertically in a ‘neck’ of the device, where the mirror 192 is obliquely mounted coaxially allowing 360-degree azimuthal fixations over the panorama.

While the embodiments illustrated in FIGS. 3A and 3B have the attentive camera 190 mounted below the mirror 192, in further embodiments, the attentive camera 190 can be mounted overtop of the mirror 19, with the lens of the attentive camera 190 directed downwards and the mirror 192 angled obliquely upwards.

The system 100 illustrated in FIGS. 3A and 3B includes four posts that support the mirror-motor assembly and can generate small regions of occlusion within the attentive FoV. Due to the 8 proximity of these posts to the lens and the substantial lens aperture, each pixel of the attentive image still receives light from beyond the posts. This allows the contribution of the posts to the captured image to be suitably identified and removed. In further cases, the mirror-motor assembly can be supported by a transparent material, for example a plexiglass enclosure, such that the posts are not present.

While the embodiment illustrated in FIGS. 3A and 3B only controls the azimuth of gaze of the attentive camera 190 (i.e., the gaze elevation is generally fixed to horizontal), further implementations can further incorporate motor control of the elevation of the gaze of the attentive camera 190. In this way, the device 188 would be able to better capture people in the near and mid-fields of largely differing heights; for example, small children, people that are sitting, people that are lying down, etc.

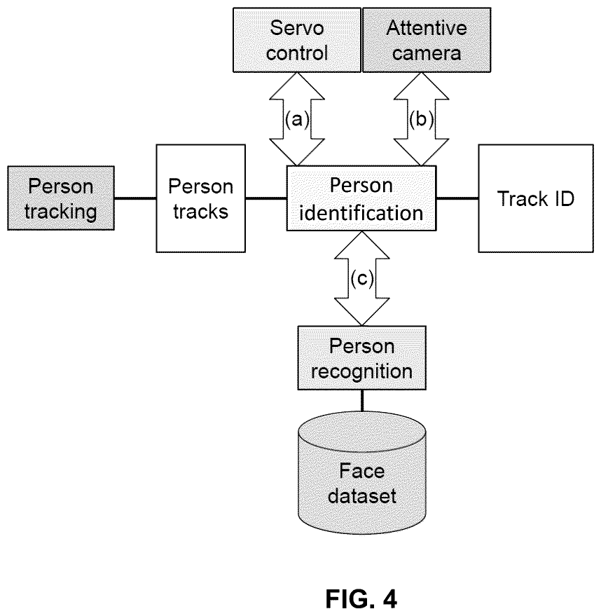

FIG. 4 illustrates an example functional pipeline for implementation of the system 100. Boxes with a background represent functional components, and boxes without a background represent information exchanged between components. The pre-attentive module 172 (shown as ‘person tracking’) provides tracking updates to the attentive module 178 (shown as ‘person identification’). A tracked subject is selected and, if the face is predicted to be within the attentive FoV, the controller module 174 directs the servo motor 196 controlling the mirror 192 to point to the latest coordinates of the tracked person. The attentive module 178 then retrieves an image from the attentive camera 190. If the face is determined or predicted to fall below or above the attentive FoV, it will be in the near or mid-field and a facial image can be obtained by, for example, cropping the top 38% of the person bounding box. In either case, the attentive module 178 can use the image with the associated track identification for facial recognition or other types of fine-grain social analysis (e.g., facial expression, age, gender, or the like).

FIG. 18 is an example diagram showing pre-attentive image acquisition and attentive focus to illustrate how all faces fall within the attentive FoV except for those of the two people closest to the device because one person is short and one person is tall.

The present inventors conducted example experiments to illustrate and verify the substantial advantages of the present embodiments. In the example experiments, pre-attentive sensing was provided by four 1280×720 pixel RGBD cameras mounted horizontally at 90 deg intervals. With nearly 90 horizontal FoV, the pre-attentive sensing cameras collectively provided a panoramic pre-attentive FoV. In the example experiments, due to bandwidth limitations, the pre-attentive panoramic resolution was 2560×360 pixels.

In the examples experiments, attentive sensing was provided by a 3840×2160 pixel camera with an 18-200 mm powered zoom lens 198 fixed at its longest focal length; yielding an 8.5 degree horizontal FoV. The (linear) visual acuity of the attentive stream was roughly 81 times higher than the pre-attentive stream (8 arcsec vs 11 arcmin). The attentive camera 190 was mounted vertically below the pre-attentive sensors and centred horizontally so that its lens passed between the pre-attentive sensors and its vertical optic axis roughly intersected with their horizontal axes.

In the examples experiments, attentive gaze control was provided by a mirror 192 mounted at a 45 degree angle on a servo motor 196 coaxial with the attentive optic axis. Rotation of the motor shifted the azimuth of the attentive FoV, providing attentive resolution in any direction of interest identified from the pre-attentive stream.

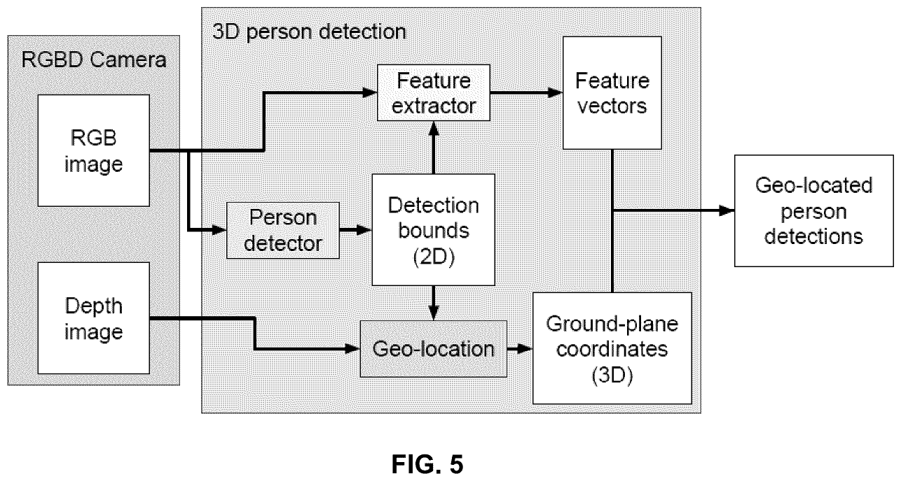

FIG. 5 illustrates a conceptual flow diagram for an implementation of the system 100 for person detection and tracking in three-dimensional (3D) space using an array of RGBD cameras. In this implementation, people are detected in the RGB stream by the pre-attentive module 172. The pre-attentive module 172 extracts an appearance feature vector and 3D geo-coordinates for each person detected in each pre-attentive frame.

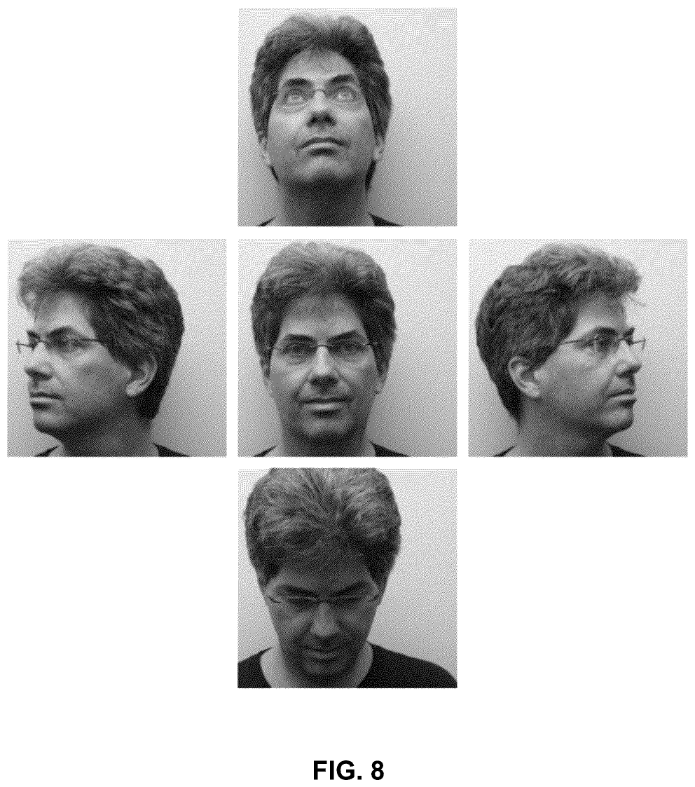

The example experiments used eleven volunteers as subjects. For each subject, a reference data store of face images was created, with their head in five different poses (as illustrated in FIG. 8). The poses were generated by asking the subject to rotate their head to direct their gaze toward five different markers on the wall, floor and ceiling, while maintaining a central position of their eyes in their head. Images were captured in uniform lighting against a blank wall, using a high-resolution digital single-lens reflex (DSLR) camera.

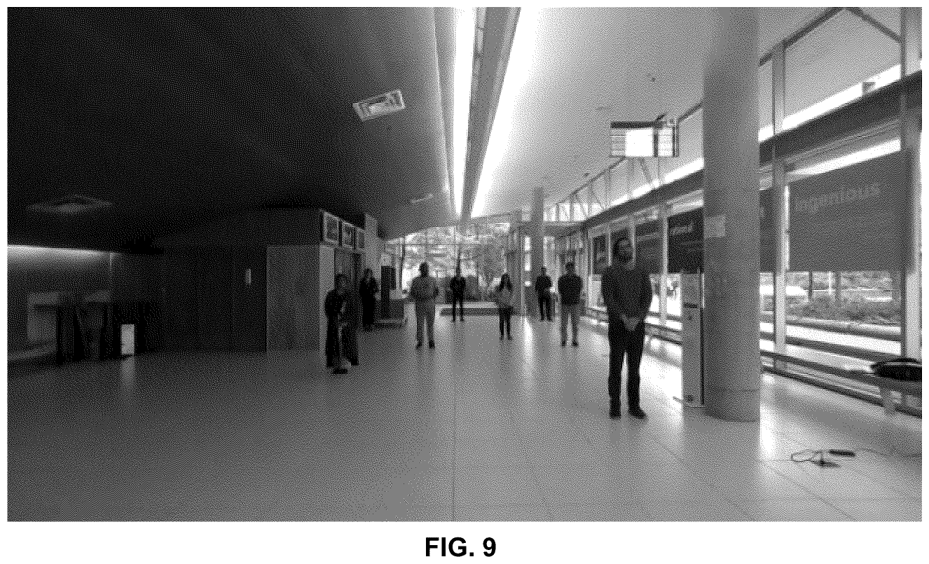

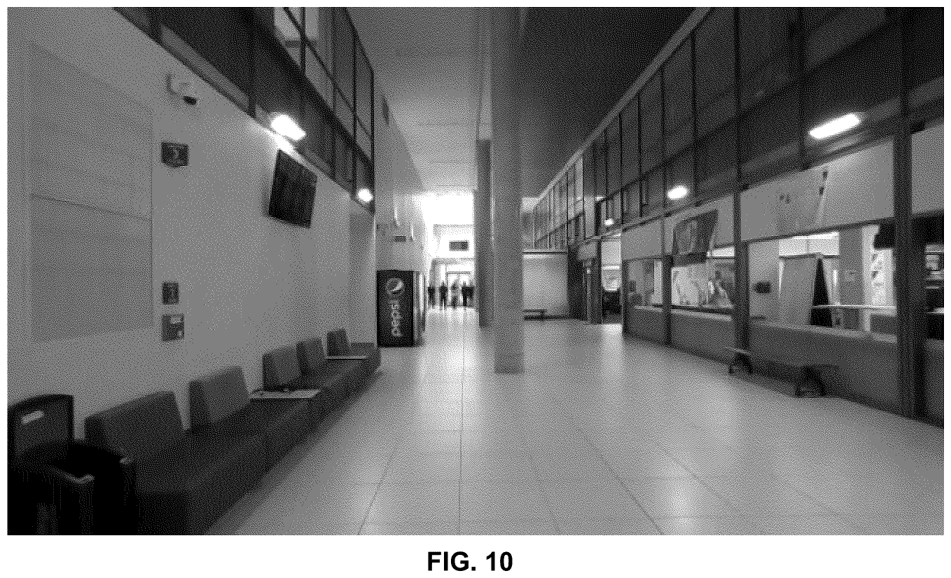

The example experiments evaluated the system 100 in two different indoor environments: a relatively open 25×7 m rectangular foyer illustrated in FIG. 9, and a longer corridor that allowed us to stretch distances to 35 m illustrated in FIG. 10. Subjects stood at various distances from the sensor, often looking towards it, but sometimes looking to the side as they talked to each other or gazing down at mobile devices.

The example experiments evaluated the performance of face detection and face recognition at pre-attentive and attentive resolution. While face detection was evaluated on uncropped pre-attentive and attentive image streams, face recognition was evaluated on manually annotated face bounding boxes for fair comparison.

The example experiments tested six face detection approaches: (1) Haar Cascades, (2) ResNet-10, (3) HoG+SVM, (4) MTCNN, (5) RetinaFace, and (6) BlazeFace. Each detector returned a confidence for each face detected; varying a threshold on this confidence swept out a precision-recall curve. Above-threshold detections were associated with ground truth faces by solving for the assignment that maximizes average intersection over union (IoU), using the Hungarian algorithm. Assignments with IoU over 0.5 were considered positive results.

The example experiments tested eight face recognition approaches: (1) VGG-Face, (2) Facenet with 128- and 512-dimension vectors, (3) OpenFace, (4) DeepFace, (5) DeepID, (6) ArcFace, (7) Dlib that is a customized version of ResNet-34, and (8) SFace. To evaluate the face recognition approaches, each of the 11 subjects in the reference data store were selected in turn as a query ID. Each in-the-wild attentive and pre-attentive facial image was then considered, identifying its minimum cosine distance to the five reference data store images of the query ID. Varying a threshold on this minimum cosine distance swept out a receiver operating characteristic (ROC) curve for each approach.

Four of the six detectors tested failed to detect any faces in the pre-attentive stream, and RetinaFace and MTCNN managed to detect only a few faces, achieving average precision (AP) scores of 0.074 and 0.004, respectively.

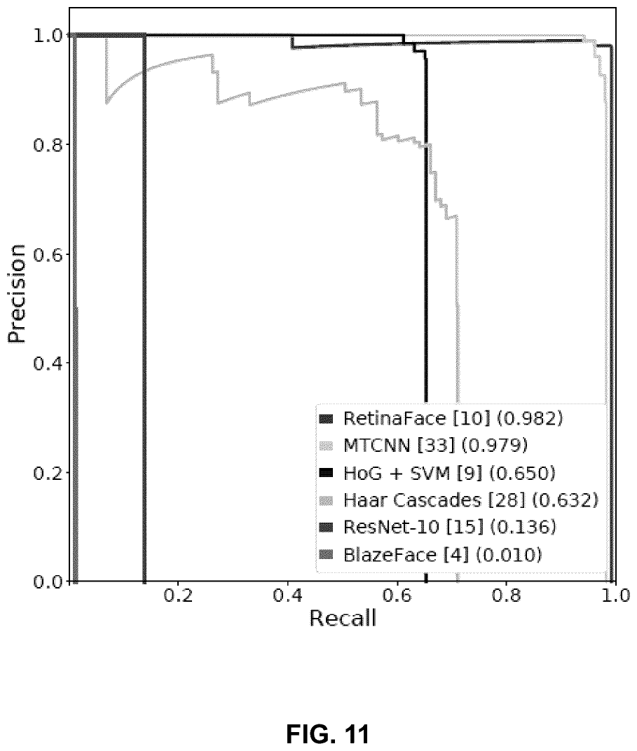

Face detection performance was generally better in the attentive stream, see the chart of FIG. 11 (which omits results for pre-attentive images are omitted because no approach could detect faces to any relevant degree). This performance demonstrates the benefit of attentive sensing for accurate panoramic face detection. RetinaFace achieved near-perfect performance, followed closely by MTCNN. ResNet-10 and BlazeFace are light models that trade accuracy for speed and are meant for use in mobile devices to locate close faces-which achieved the worst results. Haar Cascades and HoG+SVM achieved intermediate results, better than ResNet-10 and BlazeFace but worse than SoTA deep models.

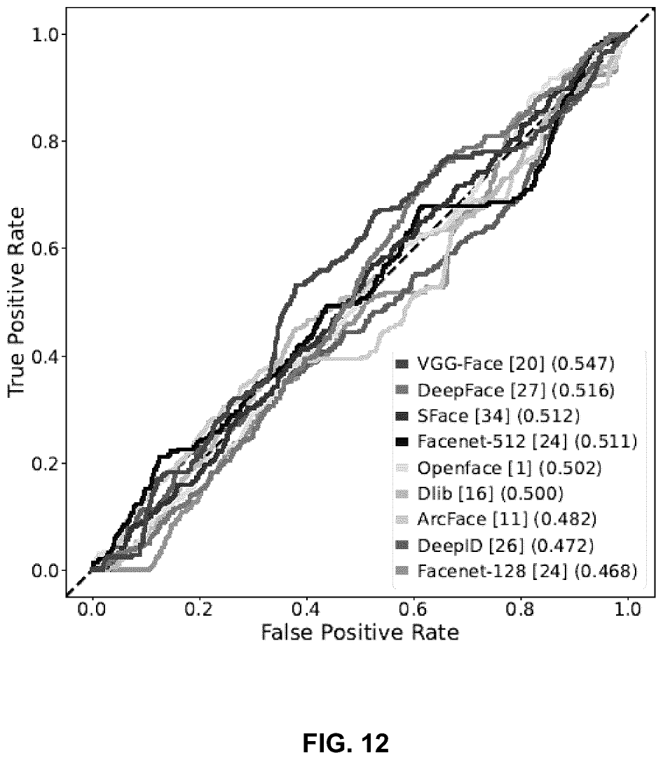

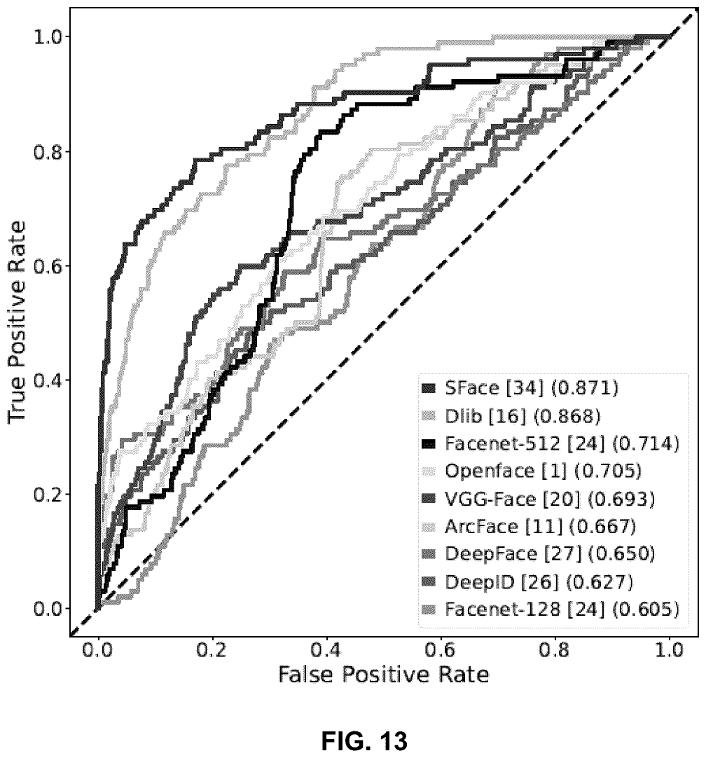

All face recognition approaches performed at or near chance on the pre-attentive images, as illustrated in the chart of FIG. 12. Face recognition performance was much better on the attentive images, as illustrated in the chart of FIG. 13. This result demonstrates the benefit of attentive sensing for panoramic face recognition. The strongest model was SFace, which uses a MobileNet backbone and is trained using a loss function robust to outliers.

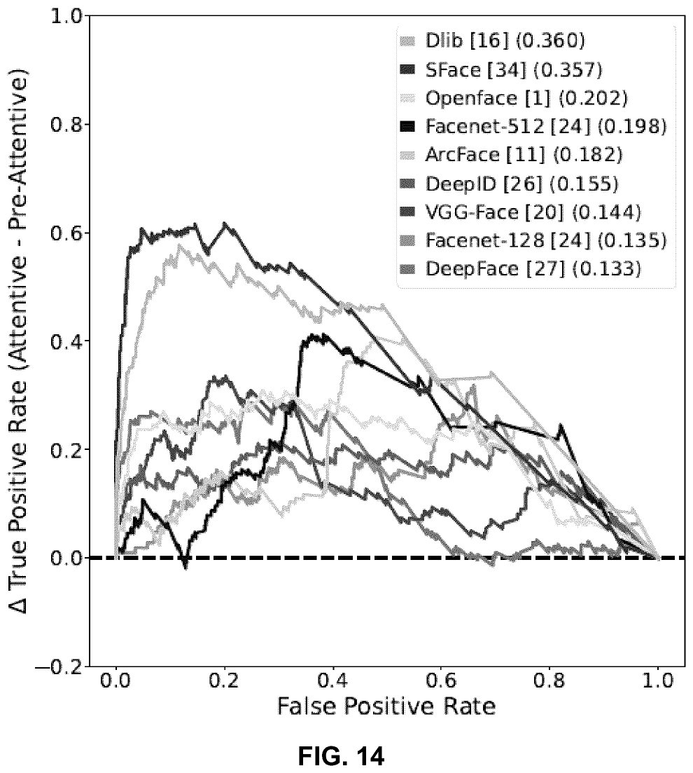

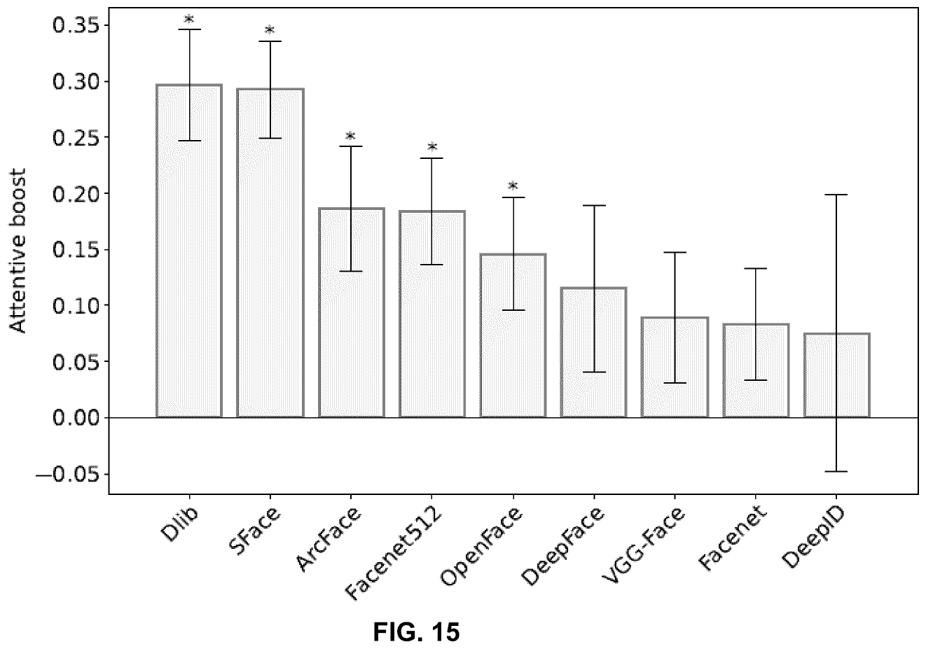

FIG. 14 is a chart illustrating differences between the attentive and pre-attentive ROC curves to show the improvement in face recognition performance due to attentive sensing. All approaches had a substantial boost from attentive sensing. To test the statistical significance of this attentive boost, the example experiments measured the equal-error-rate accuracy separately for each model and each individual in the reference data store, using both pre-attentive and attentive streams, and then performed a matched-sample t-test of the mean equal-error-rate accuracy for attentive vs pre-attentive sensing for each model. FIG. 15 is a chart illustrating attentive boost in face recognition performance, and shows that attentive sensing produces an attentive boost in equal-error-rate accuracy of up to 30%. The statistical testing suggests that, for 5 of the 9 models (Dlib, SFace, ArcFace, Facenet512 and OpenFace), this attentive boost should generalize to new datasets. In FIG. 15, bars and error bars indicate mean and standard error of the increase in equal-error-rate accuracy for attentive vs pre-attentive sensing; where ‘*’ indicates statistical significance at the p=:05 level.

TABLE 1 shows the distribution of reference data store head poses matched by SFace: where slightly less than half were frontal, with the remaining distributed across the other four head directions.

TABLE 1

| Direction | Attentive | Pre-attentive |
|---|---|---|
| Forward | 45.1% | 46.6% |
| Up | 10.0% | 5.9% |
| Down | 12.6% | 5.6% |
| Left | 15.4% | 19.7% |
| Right | 16.9% | 22.2% |

The example experiments clearly demonstrate the substantial advantages of attentive sensing for both face detection and face recognition. While it may be possible to demonstrate long-range recognition for a small FoV by employing a lens with a long focal length, the present embodiments instead advantageously provide attentive vision for long-range face recognition over a panoramic FoV; which can be particularly important for social robot applications.

The present embodiments provide a number of substantial advantages over existing approaches. For example, embodiments of the present disclosure can advantageously have panoramic 360-degree gaze of the attentive camera, as would generally be needed for an application to a holonomic robot, for example. Additionally, embodiments of the present disclosure advantageously allow the high-resolution attentive camera to be embedded vertically in the neck of the structure; such that the system does not have to move the heavy and precise attentive camera.

Additionally, embodiments of the present disclosure advantageously allow selection of where to direct the high-resolution gaze of the attentive camera based upon lower-resolution and smaller FoV information from the pre-attentive camera. Additionally, embodiments of the present disclosure advantageously provide smooth integration of pre-attentive and attentive sensing to allow high-resolution imaging of faces and other important fine detail in both the near and far fields by exploiting the fact that faces that appear below or above the attentive FoV are relatively near to the sensor and can thus be analyzed by directly cropping the pre-attentive image. This reduces the need for complex multi-joint assemblies or multi-mirror assemblies. Additionally, embodiments of the present disclosure advantageously provide an approach for predetermining the required attentive focus, which allows the focus to be adjusted before and during the mirror actuation to redirect attentive gaze, thus speeding operation.

The present embodiments can have a number of suitable applications, such as in long-term care facilities, educational environments, home assistance, security, and surveillance, among many others.

Although the foregoing has been described with reference to certain specific embodiments, various modifications thereto will be apparent to those skilled in the art without departing from the spirit and scope of the invention as outlined in the appended claims.

1. A computer-implemented method for capturing high resolution images of a scene for analysis of one or more persons, the scene comprising the one or more persons to be analyzed, the method comprising:
receiving one or more pre-attentive images, the one or more pre-attentive images capturing the scene;
detecting one or more persons in the one or more pre-attentive images;
determining a feature vector and a geo-location for at least one of the detected persons in the pre-attentive image, the geo-location comprising an azimuthal location;
matching the feature vector and geo-location to a previously detected person for tracking of such detected person, and where there is no match, initializing a tracking of a new person;
receiving an attentive image that captures the tracked person by directing gaze at the azimuthal location, the attentive image comprising a smaller field-of-view (FoV) than the one or more pre-attentive images; and
outputting the attentive image.

2. The method of claim 1, wherein identifying the detected person comprises performing facial analysis, and wherein receiving the attentive image that captures the detected person by directing gaze at the azimuthal location is performed when a face of the detected person is capturable within the field of view of the attentive image.

3. The method of claim 2, wherein when the face of the detected person is not capturable within the field of view of the attentive image, the method further comprising extracting a cropped portion of the pre-attentive image associated with a facial region of the detected person.

4. The method of claim 1, wherein the one or more pre-attentive images comprise a panoramic view of the scene.

5. The method of claim 1, further comprising recognizing the detected person by matching a vector associated with the detected person to vectors in a data store, and outputting a positive recognition where the vector is matched to the data store, and outputting a negative recognition otherwise.

6. The method of claim 1, wherein the one or more pre-attentive images comprises depth information, and wherein receiving the attentive image further comprises pre-focusing using a focus determined from the depth information.

7. The method of claim 6, wherein the tracking uses ground-plane coordinates.

8. The method of claim 7, wherein detection of the one or more persons comprises a bounding box around the detected person, wherein where depth information is available within the bounding box and a central tendency of the depth information is less than a predetermined distance, geo-location of the detected person comprises an azimuth of a spatial parameter of the bounding box at a distance determined by a central tendency of the depth information within the bounding box, and wherein where depth information is not available within the bounding box or the central tendency of the depth information exceeds the predetermined distance, geo-location of the detected person comprises back-projecting a center of the bottom of the bounding box to a ground plane.

9. The method of claim 8, wherein matching the feature vector and the geo-location to the previously detected person comprises using a metric that combines a distance measure between feature vectors and Euclidean distance in ground plane coordinates.

10. A system for capturing high resolution images of a scene for analysis of one or more persons, the scene comprising the one or more persons to be analyzed, the system comprising one or more processors in communication with a data storage, the system in communication with one or more pre-attentive cameras and an attentive camera, the one or more processors, using instructions stored on the data storage, are configured to execute:
a pre-attentive module to receive one or more pre-attentive images from the one or more pre-attentive cameras, the one or more pre-attentive images capturing the scene, to detect one or more persons in the one or more pre-attentive images, to determine a feature vector and a geo-location for at least one of the detected persons in the one or more pre-attentive images, the geo-location comprising an azimuthal location, and to match the feature vector and geo-location to a previously detected person for tracking of such detected person, and where there is no match, initializing a tracking of a new person;
an attentive module to receive an attentive image that captures the tracked person by directing a gaze of the attentive camera at the azimuthal location, the attentive image comprising a smaller field-of-view (FoV) than the one or more pre-attentive images; and
an output module to output the attentive image.

11. The system of claim 10, wherein identifying the detected person comprises performing facial analysis, and wherein receiving the attentive image that captures the detected person by directing gaze at the azimuthal location is performed when a face of the detected person is capturable within a field of view of the attentive image.

12. The system of claim 11, wherein when the face of the detected person is not capturable within the field of view of the attentive image, the attentive module extracts a cropped portion of the pre-attentive image associated with a facial region of the detected person.

13. The system of claim 11, wherein focusing is performed approximately in parallel with directing the gaze of the attentive camera at the azimuthal location.

14. The system of claim 12, wherein the tracking uses ground-plane coordinates, and wherein detection of the one or more persons comprises a bounding box around the detected person, wherein where depth information is available within the bounding box and a central tendency of the depth information is less than a predetermined distance, geo-location of the detected person comprises an azimuth of a spatial parameter of the bounding box at a distance determined by a central tendency of the depth information within the bounding box, and wherein where depth information is not available within the bounding box or the central tendency of the depth information exceeds the predetermined distance, geo-location of the detected person comprises back-projecting a center of the bottom of the bounding box to a ground plane.

15. The system of claim 13, wherein matching the feature vector and the geo-location to the previously detected person comprises using a metric that combines a distance measure between feature vectors and Euclidean distance in ground plane coordinates.

16. A device for capturing high resolution images of a scene for analysis of one or more persons, the scene comprising the one or more persons to be analyzed, the device comprising:
one or more pre-attentive cameras positioned to capture one or more pre-attentive images that combined provide a panoramic view of the scene;
a mirror mounted on a controllable structure to direct a gaze of the mirror to a specified area of the panoramic view, the specified area comprising the person to be analyzed;
an attentive camera directed towards the mirror to capture an attentive image comprising the directed gaze of the mirror of the scene, the attentive image comprising a smaller field-of-view (FoV) than the combination of the one or more pre-attentive images.

17. The device of claim 16, wherein the mirror is positioned at an oblique angle relative to horizontal, and wherein the attentive camera is directed towards the mirror and positioned above or below the mirror.

18. The device of claim 17, wherein the panoramic view comprises a 360-degree panoramic view and wherein the controllable structure comprises a motor that provides 360-degree rotation of the mirror to permit 360-degree azimuthal fixations over the panoramic view.

19. The device of claim 17, wherein the controllable structure further comprises a second motor to control an elevation of the gaze of the mirror.

20. The device of claim 16, wherein the one or more pre-attentive images are used to detect one or more persons in the one or more pre-attentive images and used to determine a feature vector and a geo-location for at least one of the detected persons in the pre-attentive image, the geo-location comprising an azimuthal location, wherein the motor directs the gaze of the mirror to the azimuthal location, and wherein the attentive image captured by the attentive camera comprises an image of the azimuthal location.
